(19) United States
(12) Patent Application Publication
(10) Pub. No.: US 2013/0054739 A1
(43) Pub. Date: Feb. 28, 2013

(54) DATA TRANSMISSION SYSTEM AND DATA TRANSMISSION METHOD

(71) Applicant: Lu-Kang Mao, Hsinchu (TW)

(72) Inventor: Lu-Kang Mao, Hsinchu (TW)

(73) Assignee: LITE-ON IT CORPORATION, Taipei (TW)

(21) Appl. No.: 13/397,795

(22) Filed: Feb. 16, 2012

(30) Foreign Application Priority Data
Aug. 31, 2011 (CN) 201110253993.X

(51) Int. Cl. G06F 15/16

(52) U.S. Cl. 709/217

(57) ABSTRACT

A data transmission system includes a home storage device, a cloud storage device, and a portable electronic apparatus. The home storage device is in communication with a network, wherein a plurality of files and a corresponding file list are stored in the home storage device. The cloud storage device is in communication with the network for receiving the file list and a first portion of each file from the home storage device. The portable electronic apparatus is in communication with the network. After a specified file is selected from the file list provided by the cloud storage device through the portable electronic apparatus, the first portion of the selected file from the cloud storage device is received by the portable electronic apparatus, and a second portion of the selected file from the home storage device is received by the portable electronic apparatus.

This application claims the benefit of People's Republic of China Application Serial No. 201110253993.X, filed Aug. 31, 2011, the subject matter of which is incorporated herein by reference.

### FIELD OF THE INVENTION

The present invention relates to a data transmission system and a data transmission method, and more particularly to a data transmission system and a data transmission method for transmitting a video/audio data stream.

### BACKGROUND OF THE INVENTION

With increasing development of science and technology, portable electronic apparatuses such as smart phones, tablet personal computers and notebook computers are now rapidly gaining in popularity. Recently, a remote access technology is developed. The remote access technology may enable people to connect the portable electronic apparatus (e.g. a smart phone, a tablet personal computer and a notebook computer) with a computer network from any location. As the portable electronic apparatuses become more popular, the demand on the remote access technology is growing.

Basically, the remote access technology may be employed to access the data stored in a home computer through a network. The home computer is a home server or a network-attached storage (NAS) device. For example, the user may operate a smart phone to copy a NAS document into the smart phone.

In a more advanced remote access technology, a digital media library is set through the home server or the NAS device. Consequently, the remote access technology may enable people to access songs or videos at any time and wherever they are, and the people may listen to the downloaded songs or watch downloaded videos through smart phones.

Nowadays, cloud music/video services have been disclosed by some companies (e.g. Google, Amazon or Apple). The cloud music/video services may be classified into two types.

The first type of cloud music/video service is a digital locker. The digital locker is a paid download service. The user may pay for the access of the digital contents in the server through the network, and the desired digital contents may be downloaded to any other computer in order to be watched and listened. However, the services provided by the digital locker need to be paid before use.

The second type of cloud music/video service is a cloud storage device. The cloud storage device has a storage space for storing the digital contents which are uploaded by the user. After the digital contents are uploaded into the cloud storage device, the digital contents are accessible by the user through the network at any time and wherever they are. Generally, the capacity of the free storage space provided by the cloud storage device is very small. If a larger storage space of the cloud storage device is required, it is necessary to additionally pay some fees before the larger storage space is used.

For most consumers, the above two types of cloud music/video services have some disadvantages such as high cost or low storage space. Therefore, there is a need of providing an improved data transmission system and an improved data transmission method in order to efficiently integrate the current cloud service with the home server or the NAS device. In such way, the digital media library can be efficiently transmitted to the portable electronic apparatus of the user.

### SUMMARY OF THE INVENTION

An embodiment of the present invention provides a data transmission system. The data transmission system includes a home storage device, a cloud storage device, and a portable electronic apparatus. The home storage device is in communication with a network, wherein a plurality of files and a corresponding file list are stored in the home storage device. The cloud storage device is in communication with the network for receiving the file list and a first portion of each file from the home storage device, wherein the first portion is an initial portion of the corresponding file. The portable electronic apparatus is in communication with the network. After a specified file is selected from the file list provided by the cloud storage device through the portable electronic apparatus, the first portion of the selected file from the cloud storage device is received by the portable electronic apparatus, and a second portion of the selected file from the home storage device is received by the portable electronic apparatus. The second portion is the rest of the selected file excluding said first portion.

Another embodiment of the present invention provides a data transmission method. The data transmission method includes the following steps. Firstly, a file is selected from a file list, which is stored in a cloud storage device. Then, a first portion of the selected file from the cloud storage device is received, and the first portion of the selected file is stored into a portable electronic apparatus, wherein the first portion is an initial portion of the selected file. Then, a second portion of the selected file from a home storage device is received, and the second portion of the selected file is stored into the portable electronic apparatus, wherein the second portion is the rest of the selected file excluding said first portion. Afterwards, the first portion and the second portion of the selected file are sequentially played by the portable electronic apparatus.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrates the architecture of a data transmission system according to an embodiment of the present invention; and

FIG. 2 is a flowchart illustrating a data transmission method according to an embodiment of the present invention.

### DETAILED DESCRIPTION OF PREFERRED EMBODIMENTS

The present invention provides a data transmission system and a data transmission method. In accordance with the present invention, a digital media library may be set through a home storage device (e.g. a home server or a NAS device) at the location where the user needs (e.g. at home or in the office), and the home storage device may be in communication with a network. Moreover, the digital contents (e.g. music files or video files) in the home storage device may be updated by the user at any time. Obviously, since the user can expand the storage space of the home storage device, the limitation of the storage space of the conventional cloud storage device will be eliminated.

Moreover, the storage space (e.g. the free storage space) provided by the cloud storage device may be utilized by the data transmission system and the data transmission method of the present invention. In addition, the file list of the digital media library in the home storage device may be stored in the cloud storage device. After the digital contents in the home storage device have been updated by the user, the updated file list may be automatically stored into the cloud storage device from the home storage device. That is, the file list in the cloud storage device is in synchronization with the file list in the home storage device.

In accordance with the present invention, the file list of the cloud storage device and the file list of the home storage device are in synchronization. Moreover, a first portion of each file is also transmitted from the home storage device to the cloud storage device. After a file is selected by the user through a smart phone, the first portion of the selected file will be transmitted from the cloud storage device to the smart phone. After the first portion of the selected file has been completely transmitted to the smart phone, the other portions of the selected file are continuously provided to the smart phone by the home storage device. The operating principles of the present invention will be illustrated as follows.

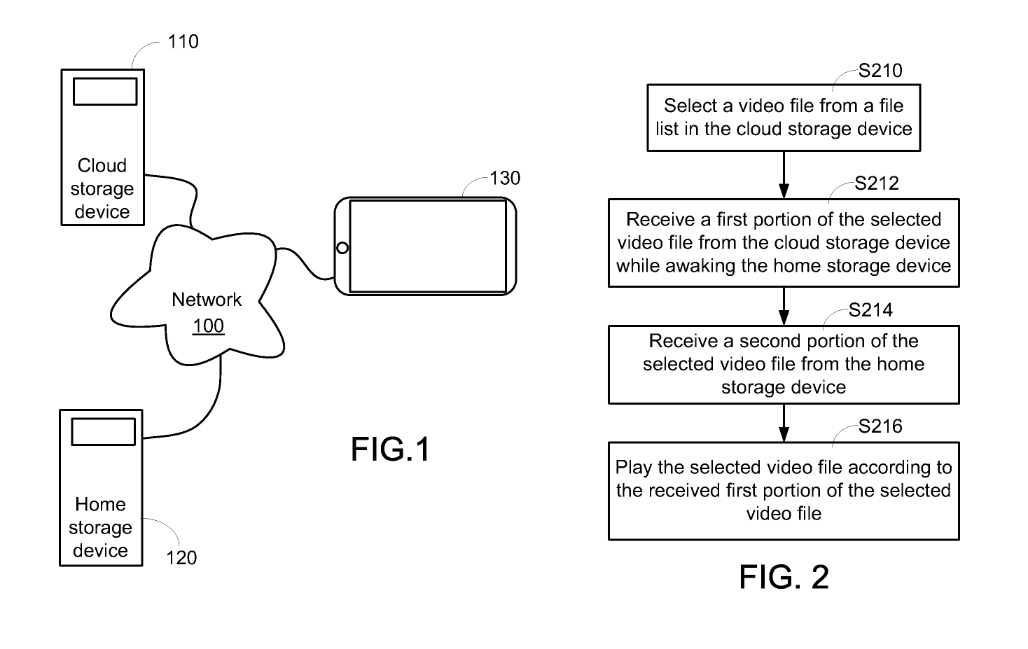

FIG. 1 schematically illustrates the architecture of a data transmission system according to an embodiment of the present invention. As shown in FIG. 1, the data transmission system comprises a cloud storage device 110, a home storage device 120, and a smart phone 130. The smart phone 130 may be replaced by any other portable electronic apparatus (e.g. a tablet personal computer or a notebook computer). Moreover, the cloud storage device 110, the home storage device 120 and the smart phone 130 are in communication with a network 100 in a wired transmission manner or a wireless transmission manner.

In this embodiment, since the storage capacity of the home storage device 120 may be expanded by the user, the storage capacity of the home storage device 120 will not be limited. In such way, a digital media library with a large amount of data may be established by the user. Moreover, according to the user's requirements, the digital contents in the home storage device may be updated by the user at any time. After the digital contents in the home storage device are updated by the user, the updated file list in the home storage device 120 will be transmitted to the cloud storage device 110. Consequently, the file list in the cloud storage device 110 will be updated.

Moreover, a first portion of each file may be transmitted from the home storage device 120 to the cloud storage device 110, so that all files in the home storage device 120 are partially retained in the cloud storage device 110. Consequently, even if the storage capacity of the cloud storage device 110 is limited, the file list and first portion of all files can be stored into the cloud storage device 110. Moreover, for reducing power consumption of the home storage device 120, if the home storage device 120 is not used, the home storage device 120 is in a sleep mode.

In this embodiment, a data transmission application program is further installed in the smart phone 130. In a case that the user wants to download or play a specified file, the user may operate the smart phone 130 to read the file list from the cloud storage device 110. That is, after a specified file is selected from the file list by the user, the first portion of the specified file will be transmitted from the cloud storage device 110 and temporarily stored in the smart phone 130.

When a first data steam of the first portion of the specified file starts to be received or downloaded by the smart phone 130, the home storage device 120 is awaked and enters a working mode. After the first data steam of the first portion of the specified file has been completely transmitted to the smart phone 130, the home storage device 120 has entered the working mode. At the same time, the data streams of the other portions of the specified file are continuously transmitted to the smart phone 130. For example, during a video file is watched by the user through the smart phone 130, the first portion of the video file is provided by the cloud storage device 110, and the other portions of the video file are provided by the home storage device 120.

FIG. 2 is a flowchart illustrating a data transmission method according to an embodiment of the present invention. Hereinafter, the selected file will be illustrated by referring to a video file. Nevertheless, the selected file may be a music file or any other file.

Firstly, in the step S210, a video file is selected from a file list in the cloud storage device 110. Then, in the step S212, a first portion of the selected video file from the cloud storage device 110 starts to be received and the home storage device 120 starts to be awaked. After the home storage device 120 is awaked, a second portion of the selected video file from the home storage device 120 starts to be received (Step S214). Even if the data of the first portion of the selected video file has not been completely received, the first portion of the selected video file from the cloud storage device 110 and the second portion of the selected video file from the home storage device 120 may be simultaneously received by the smart phone 130. Then, in the step S216, the smart phone 130 starts playback of the selected video file according to the received first portion of the selected video file. The smart phone 130 can play the received first portion of selected video file even if the first portion or the second portion is not completely received. Of course, after the first portion of the selected video file has been completely played, since the second portion of the selected video file is also provided by the home storage device 120, the second portion of the selected file is continuously played by the smart phone 130. In other words, the first portion and the second portion of the selected file are sequentially played by the smart phone 130.

From the above discussion, the data transmission application program in the smart phone 130 is executed to automatically switch the data source without the need of notifying the user. Consequently, the selected video file can be smoothly played. In addition, during the process of watching the selected video file, the user is not conscious that the data source has been switched.

Moreover, the size of the first portion of the selected file may be arbitrarily determined according to the practical requirements. For example, if it takes 20 seconds for the home storage device 120 to enter the working mode from the sleep mode, the first portion of the selected file in the cloud storage device 110 may be set to have a size required to play the selected file for the first 20 seconds. In addition, the files with different sizes are transmitted to the cloud storage device 110 according to different encoding approaches. After the home storage device 120 is awaked, the second portion of the selected file can be instantly transmitted to the smart phone 130, so that the seamless data transmission is achieved. Alternatively, the first portion of the selected file may be directly set to have a fixed size lower than the size of the selected file. In other words, the fixed size of each file in the home storage device 120 may be extracted and transmitted to the cloud storage device 110.

Moreover, the cloud storage device 110 may be provided by the manufacturer of the home storage device 120. By integrating the cloud storage device 110, the home storage device 120 and the cloud storage device 110, the data transmission system is capable of efficiently transmitting digital data.

From the above discussions, according to a communication protocol defined by the data transmission application program installed in the smart phone 130, the transmission of the selected file between the cloud storage device 110 and the home storage device 120 can be effectively controlled. As a consequently, the selected file can be smoothly played by the smart phone 130.

From the above description, a digital media library with a large amount of data may be established in the home storage device 120 by the user. In addition, the file list in the digital media library and the first portion of all files can be stored in the cloud storage device 110 in a cost-effective manner. Consequently, the data transmission system and the data transmission method of the present invention are capable of efficiently transmitting the video/audio data stream.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data transmission system, comprising:
a home storage device in communication with a network, wherein a plurality of files and a corresponding file list are stored in the home storage device;
a cloud storage device in communication with the network for receiving the file list and a first portion of each file from the home storage device, wherein the first portion is an initial portion of the corresponding file; and
a portable electronic apparatus in communication with the network, wherein after a specified file is selected from the file list provided by the cloud storage device through the portable electronic apparatus, the first portion of the selected file from the cloud storage device is received by the portable electronic apparatus, and a second portion of the selected file from the home storage device is received by the portable electronic apparatus, wherein the second portion is the rest of the selected file excluding said first portion.

2. The data transmission system as claimed in claim 1, wherein the portable electronic apparatus is a smart phone, a tablet personal computer, or a notebook computer.

3. The data transmission system as claimed in claim 1, wherein the home storage device a home server or a network-attached storage device.

4. The data transmission system as claimed in claim 1, wherein the plurality of files in the home storage device comprise a plurality of music files and a plurality of video files.

5. The data transmission system as claimed in claim 1, wherein before the second portion of the selected file from the home storage device is received by the portable electronic apparatus, the home storage device is switched from a sleep mode to a working mode.

6. The data transmission system as claimed in claim 1, wherein the first portion of the selected file has a fixed size lower than a size of the selected file.

7. The data transmission system as claimed in claim 1, wherein the first portion of the selected file has a size corresponding to a fixed playback time of the selected file.

8. A data transmission method, comprising steps of:
selecting a file from a file list, which is stored in a cloud storage device;
receiving a first portion of the selected file from the cloud storage device, and storing the first portion of the selected file into a portable electronic apparatus, wherein the first portion is an initial portion of the selected file;
receiving a second portion of the selected file from a home storage device, and storing the second portion of the selected file into the portable electronic apparatus, wherein the second portion is the rest of the selected file excluding said first portion; and
sequentially playing the first portion and the second portion of the selected file by the portable electronic apparatus.

9. The data transmission method as claimed in claim 8, wherein the portable electronic apparatus is a smart phone, a tablet personal computer, or a notebook computer.

10. The data transmission method as claimed in claim 8, wherein the home storage device a home server or a network-attached storage device.

11. The data transmission method as claimed in claim 8, wherein the selected file is a music file or a video file.

12. The data transmission method as claimed in claim 8, wherein before the second portion of the selected file from the home storage device is received by the portable electronic apparatus, the home storage device is switched from a sleep mode to a working mode.

13. The data transmission method as claimed in claim 8, wherein after the first portion of the selected file has been completely received by the portable electronic apparatus, the second portion of the selected file from the home storage device is continuously received by the portable electronic apparatus.

14. The data transmission method as claimed in claim 8, wherein the first portion of the selected file has a fixed size lower than a size of the selected file.

15. The data transmission method as claimed in claim 8, wherein the first portion of the selected file has a size corresponding to a fixed playback time of the selected file.
